(19) United States
(12) Patent Application Publication
(10) Pub. No.: US 2003/0188618 A1
(43) Pub. Date: Oct. 9, 2003

(54) Manually guided, motor driven implement

(75) Inventors: Johannes Menzel, Stuttgart (DE); Helmut Lux, Waiblingen (DE); Gunter Wolf, Oppenweiler (DE); Roman Allgower, Esslingen (DE); Georg Leppla, Backnang (DE); Jorg Schlossarczyk, Winnenden (DE)

Correspondence Address: ROBERT W. BECKER & ASSOCIATES, Suite B, 707 highway 66 East, Tijeras, NM, 87059, US

(73) Assignee: Andreas Stihl AG & Co., Waiblingen (DE)

(21) Appl. No.: 10/400,292

(22) Filed: Mar. 26, 2003

(30) Foreign Application Priority Data
Apr. 6, 2002 (DE) 102 15 237.3

(51) Int. Cl. B26D 1/46; B27B 17/00

(52) U.S. Cl. 83/801

(57) ABSTRACT

A manually guided, motor-driven implement is provided that has a housing for a motor, especially an internal combustion engine, that drives a working tool of the implement. In order for a power chain saw to mount a handle on the housing of the motor in a vibration dampening manner such that due to the mounting a structurally prescribed dampening frequency range is effected, one or more hydraulic mounts are disposed between the handle and the motor of the power chain saw.

### BACKGROUND OF THE INVENTION

The present invention relates to a manually guided, motor driven implement having a housing for a motor, especially an internal combustion engine, that drives a working tool of the implement, and with a handle on the housing of the motor.

Manually guided implements having an internal combustion engine are provided with anti-vibration elements for neutralizing vibrations of a handle between a handle and a housing of the motor; the anti-vibration elements can be made of rubber or springs. With these anti-vibration elements, a good dampening is possible in critical frequency ranges of a motor driven implement; however, in frequency ranges of about 30 to 80 Hz overlapping of the system resonance's of manually guided, motor driven implements and of the motor vibrations occurs, which makes an effective vibration dampening difficult. This is particularly problematic with implements that are driven with internal combustion engines and have frequently changing motor speeds. In addition, the dampening characteristics of elastomeric anti-vibration elements change as the operating time increases due to hardening of the elements.

EP 0 165 341 A1 discloses a hammer drill, the handle of which is supported on the housing of the drill via a rotationally symmetrical dampener. With such a dampener, it is possible to damper low frequencies and also higher frequencies over 200 Hz, although a broad blocking frequency range, in which the dampener dampens vibrations of the motor, is not possible.

It is therefore an object of the present invention to provide a dampener for a manually guided, motor driven implement that keeps vibrations of the motor away from the handle of the implement in a structurally prescribable blocking frequency range.

### BRIEF DESCRIPTION OF THE DRAWINGS

This object, and other objects and advantages of the present invention, will appear more clearly from the following specification in conjunction with the accompanying drawings, in which:

FIG. 1 is a schematic side view of a chain saw having hydraulic mounts;

FIG. 2 is a graph showing the spring rigidity and phase angle of a hydraulic mount plotted versus the frequency;

FIG. 3 is a graph showing the excitation function and the response function of a hydraulic mount plotted against time;

FIG. 4 is a longitudinal cross-sectional view through one exemplary embodiment of an inventive hydraulic mount; and

FIG. 5 is a cross-sectional view through an exemplary embodiment of an inventive hydraulic sleeve.

### SUMMARY OF THE INVENTION

The implement of the present invention is a power chain saw, wherein the handle is connected to the motor housing via the interposition of a hydraulic mount that cushions and dampens vibrations of the motor in a structurally prescribed blocking frequency range.

With a power chain saw, the handle of the saw is connected with the housing of the motor with the aid of a hydraulic mount. As a consequence of the structural design of the hydraulic mount, a defined blocking frequency range can be prescribed that dampens selected frequencies that are specific to the implement. During operation of the power chain saw, vibrations to the handle that adversely affect the comfort of the operator can be prevented. In this connection, the frequency range of the hydraulic mount is such that it is the same as or greater than the resonance frequency range of the manually guided implement. Thus, the operation of the power chain saw, which changes in speed and torque, can be taken into consideration, and in particular a frequency range of about 15 to 200 Hz can be realized.

It can be expedient to simultaneously connect the handle with the housing of the motor via variously constructed anti-vibration elements, such as steel springs and/or elastomeric anti-vibration elements and hydraulic mounts. In this connection, the hydraulic mount advantageously blocks excitation frequencies that coincide with system resonance's of the manually guided implement. It can also be expedient to dispose a plurality of hydraulic mounts in particular in a single plane or approximately axially parallel to one another on the handle or on extensions thereof, as a consequence of which dynamic loads are distributed to a number of hydraulic mounts and the hydraulic mounts can thereby be kept especially small.

It can, in particular as a function of the vibration characteristics and system resonance's of the power chain saw, be expedient to dampen a plurality of resonance frequencies of the power chain saw that are disposed at a distance from one another, or additively complement one another, by means of a plurality of hydraulic mounts having different frequency ranges. The hydraulic mounts are preferably cylindrical or plate-shaped structures, the radial dimensions of which are smaller or approximately the same as the local width of the locations at which they are fixed in position on the handle. In this way, the hydraulic mounts, by being disposed at least partially in recesses of the handle, can be protected from external influences.

To dampen low-amplitude and high-frequency vibrations, it is expedient to embody the hydraulic mount as an elastic or resilient mount having a fluid filled pressure chamber and a fluid filled compensation chamber that are in fluidic communication with one another. Disposed between the pressure chamber and the compensation chamber is, advantageously, an intermediate plate that is provided with a neutralization channel that acts upon a neutralization diaphragm. The neutralization diaphragm effects a lowering of the dampening and the dynamic rigidity of the hydraulic mount during high frequency and low amplitude vibrations. In this connection, the neutralization diaphragm is moved or deformed without having the hydraulic liquid flow through an equalizing channel that interconnects the pressure chamber and the compensation chamber.

Resonance phenomenon that occur in the liquid mass that is in the neutralization channel effect a lowering of the dynamic rigidity of the hydraulic mount, thereby improving the high-frequency isolation characteristic without impairing the low-frequency dampening characteristic.

In this connection, it is expedient to embody the neutralization channel with parallel walls or in a cylindrical manner, whereby the ratio of the diameter to the length of the neutralization channel should be somewhat less than four. As a consequence of this geometrical design, a good high-frequency dampening is achieved. The low-frequency dampening of the hydraulic mount is effected by the back and forth movement of the liquid in the equalizing channel between the pressure chamber and the compensation chamber with an amplitude that vibrates in the same phase with the motor. This amplitude, as the amplitude of the movements of the motor, is multiplied with the ratio from the displacement cross-section of the delimiting walls and the cross-section of the equalizing channel. During low-frequency engine operation, the amount of the dynamic rigidity of the hydraulic mount is less than when the engine is not running, as a result of which any vibrational movements of the engine during idling are isolated from the handle in an excellent manner by the hydraulic mounts.

To enable a broader range of use of the hydraulic mount, even with different models and sizes of power chain saws, the hydraulic mount is expediently designed in such a way that the respective phase angle or spring rigidity of the hydraulic mount is nearly the same, and in particular is linear, in a range of from 15 to about 200 Hz. To achieve a largely amplitude independence of the hydraulic mount, it can be expedient to dispose a hollow chamber having a compressible gas in the pressure chamber of the hydraulic mount. The hollow space, with the compressible gas, can be formed by a separate auxiliary element that is expediently formed with a casing or shell made of rubber or other elastomeric material. During low amplitudes, the auxiliary element exhibits an elastically yielding behavior, and at high amplitudes is relatively stiff due to a reduction in volume. Due to the increase in rigidity or stiffness of the auxiliary element, there again results a corresponding progressive volume rigidity of the pressure chamber itself, as a consequence of which the inherent frequency of the hydraulic mount remains largely constant at different amplitudes.

Further specific features of the present invention will be described in detail subsequently.

### DESCRIPTION OF PREFERRED EMBODIMENTS

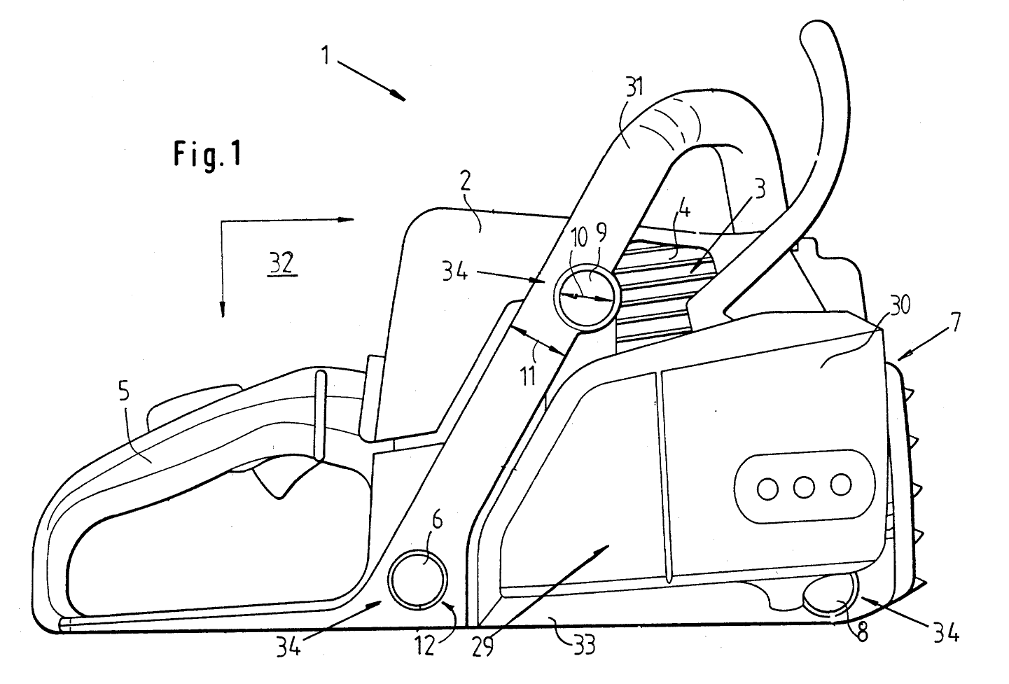

Referring now to the drawings in detail, shown in a schematic side view in FIG. 1 is a power chain saw 7 as a manually guided, motor driven implement. Disposed in a housing 2 of the power chain saw 7 is a motor 3, which in the illustrated embodiment is an internal combustion engine 4 that is embodied in particular as a two-cycle engine and serves for driving a non-illustrated working tool. The tool comprises a saw chain, which circulates upon a guide bar. The internal combustion engine is, in particular, a single cylinder internal combustion engine.

The illustrated longitudinal side 29 of the power chain saw 7 is provided with a chain wheel cover 30 with which a retention end of the guide bar is to be securely clamped to the housing 2. The power chain saw 7 has a rear handle 5 that carries the operating elements for the power chain saw. The handle 5 extends from the rear portion of the housing 2 approximately in the longitudinal central plane 32 of the power chain saw 7. At its front-end portion 33, which faces the motor 3, the handle 5 is connected with the housing 2 via two anti-vibration elements 34. The front-end portion 33 extends at least partially under the housing 2. The anti-vibration elements 34 can be hydraulic mounts 6, elastomeric anti-vibration elements 8, or steel springs 9, whereby in the illustrated embodiment at least one of the anti-vibration elements 34 is a hydraulic mount 6. Provided at an angle to the handle 5 is an upper handle 31 that is connected with the handle 5 in the region of its front end portion 33, or is monolithically formed with the handle 5. The handle 31 extends over and is spaced from the housing 2. The handle 31 is connected with the housing 2 via at least one further anti-vibration element 34.

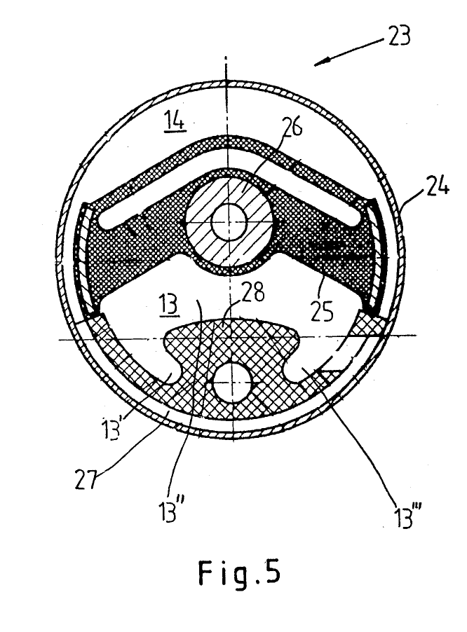

Depending upon the structural features of the power chain saw and their use, various excitation frequencies result on the housing 2. At least at locations of the housing 2 at which significant excitation frequencies occur, a hydraulic mount 6 is provided for the connection of the housing 2 to the handle 5. In the same way, the front end portion 33 and the handle 31 can be fixed in position on the motor 3 or the housing 2 with the aid of a hydraulic mount 6. The hydraulic mount 6 is, by means of suitable structural features and by the selection of the material, in particular the Shore hardness of its elastomeric spring elements or spring bodies 25 (see FIGS. 4 and 5), designed in such a way that it realizes a blocking frequency range that overlaps the excitation frequencies of the power chain saw 7. The blocking frequency range of the hydraulic mount 6 is preferably the same or greater than the resonance frequency range of a power chain saw and in a preferred embodiment of the hydraulic mount lies approximately in a range of from 15 to 200 Hz.

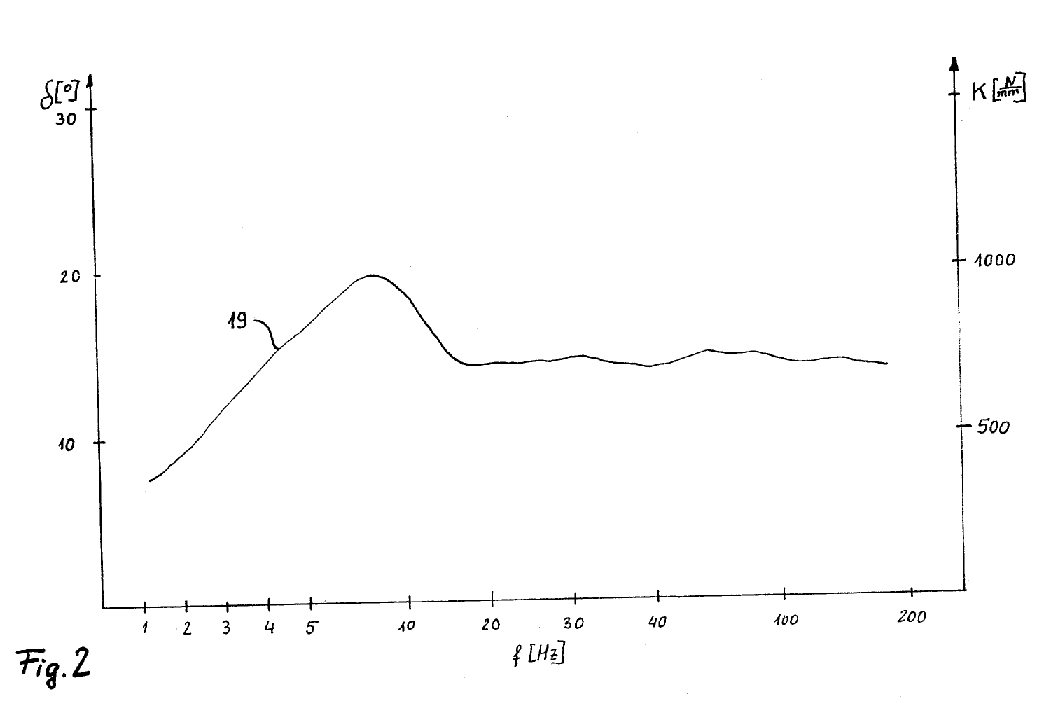

In the graph of FIG. 2, the phase angle 19 and the dynamic spring rate are plotted against the frequency. It is clear that in the illustrated frequency range, the hydraulic mount behaves linearly and uniformly with regard to its spring and dampening characteristics.

It can be expedient to connect the entire housing 2 or the motor 3 with the handle 5 and/or the handle 31 with the aid of hydraulic mounts 6. The hydraulic mounts 6 can also have structurally prescribed blocking frequency ranges that deviate from one another. Due to their easy to set dampening characteristic, it is possible to locate the hydraulic mounts at structurally favorable positions on the power chain saw 7 without having to take into consideration the vibrations that occur at the respective mounting location on the power chain saw 7.

As shown in FIG. 1, it can be expedient to dispose the hydraulic mounts 6 on the handle 5 and the handle 31 in a single plane and/or at least in such a way that their axes are parallel to one another, whereby the hydraulic mounts 6 can engage in recesses 12 of the respective handle 5 or 31. In this way, the hydraulic mounts are at least partially protected against damaging external influences. For this purpose, the hydraulic mounts 6 has a radial dimension 10 that is less than or approximately the same as the local width 11 of the handle 5 or 31 at the location where the hydraulic mount 6 is attached.

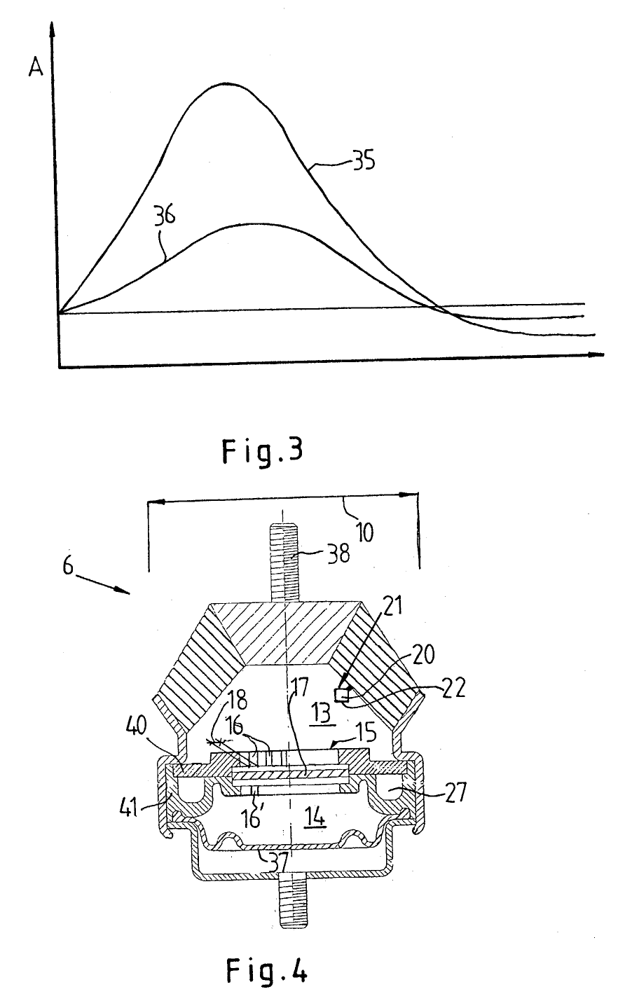

The graph of FIG. 3 shows the excitation function 35 and the response function 36 of a hydraulic mount plotted against time. By the use of hydraulic mounts, there is effected an attenuation and phase delay of the amplitude or acceleration maximum of the response function 36 relative to the excitation function 35, as well as a dampening. As a consequence of the dampening that is achieved, there is effected a reduction of the vibrational loading of the handle of the power chain saw.

FIG. 4 shows, in a longitudinal cross-sectional view through one exemplary embodiment of a hydraulic mount, the latter is preferably embodied as a cylindrical, resilient mount. The hydraulic mount 6 has a liquid filled pressure chamber 13 and a liquid filled compensation chamber 14, whereby the chambers 13 and 14 are partially delimited by elastic walls that form the spring bodies. The pressure chamber 13 and the compensation chamber 14 are fluidically interconnected via an equalizing channel 27. On that side that is opposite the pressure chamber 13, the compensation chamber 14 is delimited by an elastomeric diaphragm 37. The spring body is centrally provided with a securement bolt 38 for mounting the hydraulic mount to the motor. Provided on the opposite side of the hydraulic mount is a housing having a further securement element for mounting to the handle 5 or the handle 31. Received in an intermediate plate 15 between the pressure chamber 13 and the compensation chamber 14 is a neutralization diaphragm 17, which serves for neutralizing low-amplitude vibrations. The equalizing channel 27 effects a dampening of low-frequency, large amplitude vibrations.

The intermediate plate 15 is embodied in two parts, including an upper portion 40 and a lower portion 41, between which is disposed the neutralization diaphragm 17. Disposed in the upper portion 40 are one or more cylindrical neutralization channels 16 having the same or different diameters 18. A neutralization channel 16′ is disposed in the lower portion 41. The neutralization channel or channels 16 lead from the neutralization diaphragm 17 to the pressure chamber 13, while the neutralization channel 16′ leads from the neutralization diaphragm 17 to the compensation chamber 14. Advantageously, at least one of the neutralization channels 16 is embodied in such a way that its ratio of diameter to length is less than four. As a result of this geometrical configuration, a good high-frequency dampening is achieved. During a high-frequency loading of the hydraulic mount, the liquid in the pressure chamber 13 presses upon the neutralization diaphragm 17, which is thereby shifted, as a result of which, in turn, liquid flows through the neutralization channel or channels 16, 16′. As a function of the geometrical design of the neutralization channel 16, high-frequency, low-amplitude vibrations lead to resonance phenomenon of the liquid column accommodated in the eutralization channel or channels, along with the volume rigidity of the spring body. The blocking frequency of the hydraulic mount can be structurally fixed by the dimensions and shape of the neutralization channels 16,16′, and can be adapted to the respective power chain saw. The resonance phenomenon leads to a lowering of the dynamic rigidity and to an improvement of the high-frequency isolation.

During large-amplitude vibrations, the effect of the neutralization channels 16,16′ is reduced. In this connection, the neutralization diaphragm 17 is brought to rest against the mouths or openings of the neutralization channels 16, 16′, so that the liquid flows from the pressure chamber 17 to the compensation chamber 14 via the equalizing channel 27, and vice versa.

To achieve an amplitude independence of the hydraulic mount it can be expedient to dispose in the pressure chamber 13 of the hydraulic mount 6 a closed hollow chamber 20 that is filled with a compressible gas. The hollow chamber 20 is preferably formed by an auxiliary element 21 that is formed as a gas-filled component having a casing or shell 22 of rubber or other elastomeric material. During low amplitudes that act upon the auxiliary element 21, the latter reacts in an elastically yielding manner, whereas at high amplitudes it stiffens due to its reduction in volume. The increase of the volume rigidity of the pressure chamber 13 at high amplitudes is thereby affected. Due to these structural measures, the inherent or natural frequency of the hydraulic mount 6 remains largely constant at various amplitudes.

In order to enable a dampening about all three axes of a hydraulic mount in ranges that can be individually prescribed, it can be expedient to embody the hydraulic mount 6 as a hydraulic sleeve 23.

The cross-sectional view of FIG. 5 shows such a hydraulic sleeve 23, which is essentially formed from an outer cylindrical support body 24 that is preferably made of metallic material. Centrally disposed in the outer support body 24 is an inner support body 26, which is supported by an elastic spring body 25. The spring body 25 delimits, in the outer support body 24, a pressure chamber 13 and an equalization chamber 14, whereby the chambers 13,14 communicate with one another via an equalizing channel 27. The chambers are filled with incompressible liquid. Disposed in the pressure chamber 13 is an insert 28 that has such a shape that three partial chambers 13′, 13″ and 13′″ are formed in the pressure chamber 13 and are in flow-communication with one another. With the hydraulic sleeve 23, a lowering of the dynamic spring rate is effected in that component liquid masses experience resonance with portions of the spring body 25 and vibrate in a phase-displaced manner relative to the excitation. This effect is formed in all three axes of the hydraulic sleeve.

The specification incorporates by reference the disclosure of German priority document 102 15 237.3 filed Apr. 6, 2002.

The present invention is, of course, in no way restricted to the specific disclosure of the specification and drawings, but also encompasses any modifications within the scope of the appended claims.

1. A manually guided, motor driven power chain saw having a housing for a motor that drives a working tool of the power chain saw, wherein a handle is disposed on said housing, comprising:
a hydraulic mount, wherein said handle is connected to said housing via the interposition of said hydraulic mount, and wherein said hydraulic mount cushions and dampens vibrations of said motor in a structurally prescribed blocking frequency range.

2. A power chain saw according to claim 1, wherein said blocking frequency range of said hydraulic mount is the same as or greater than a resonance frequency range of said power chain saw.

3. A power chain saw according to claim 1, wherein said blocking frequency range of said hydraulic mount is approximately between 15 and 200 Hz.

4. A power chain saw according to claim 3, wherein a phase angle or a spring rigidity of said hydraulic mount is in the range of about 15 to 200 Hz.

5. A power chain saw according to claim 3, wherein a phase angle or a spring rigidity of said hydraulic mount is approximately the same as said blocking frequency range.

6. A power chain saw according to claim 1, wherein said handle is connected to said housing of said motor via said hydraulic mount and an elastomeric anti-vibration element or a steel spring.

7. A power chain saw according to claim 1, wherein a plurality of hydraulic mounts are disposed on said handle approximately in a single plane and in an axis-parallel manner.

8. A power chain saw according to claim 7, wherein said hydraulic mounts have different blocking frequency ranges.

9. A power chain saw according to claim 1, wherein said hydraulic mount has a radial dimension that is less than or approximately equal to a width of said handle.

10. A power chain saw according to claim 1, wherein said hydraulic mount engages at least partially in a recess of said handle.

11. A power chain saw according to claim 1, wherein said hydraulic mount is a resilient mount that is provided with a liquid filled pressure chamber and a compensation chamber that is fluidically connected with said pressure chamber, wherein said pressure chamber and said compensation chamber are at least partially delimited by resilient walls, wherein an intermediate plate is disposed between said pressure chamber and said compensation chamber, and wherein said intermediate plate is provided with at least one neutralization channel and a neutralization diaphragm.

12. A power chain saw according to claim 11, wherein said at least one neutralization channel has an essentially cylindrical configuration, and wherein a ratio of diameter to length of said at least one neutralization channel is less than four.

13. A power chain saw according to claim 12, wherein said intermediate plate is provided with a plurality of neutralization channels having different diameters.

14. A power chain saw according to claim 11, wherein a closed hollow chamber that is filled with compressible gas is disposed in said pressure chamber of said hydraulic mount, and wherein a volume of said hollow chamber is such that an inherent frequency of said hydraulic mount is approximately constant over an amplitude range of said motor.

15. A power chain saw according to claim 14, wherein said hollow chamber is formed by a separate auxiliary element.

16. A power chain saw according to claim 15, wherein said auxiliary element is a gas-filled component having a shell.

17. A power chain saw according to claim 16, wherein said shell is made of rubber or some other elastomeric material.
